(19) United States
(12) Patent Application Publication
(10) Pub. No.: US 2013/0035074 A1
(43) Pub. Date: Feb. 7, 2013

(54) SYSTEM FOR THE RECORDING AND RETRIEVAL OF VOICE MESSAGES

(71) Applicants: Laurent Tupinier, Reichstett (FR); Thibaud Barillot, Illkirch (FR)

(72) Inventors: Laurent Tupinier, Reichstett (FR); Thibaud Barillot, Illkirch (FR)

(73) Assignee: DELPHI TECHNOLOGIES, INC., TROY, MI (US)

(21) Appl. No.: 13/640,640

(22) PCT Filed: Mar. 14, 2011
(86) PCT No.: PCT/EP2011/053799

§ 371 Date: Oct. 11, 2012

(30) Foreign Application Priority Data
Apr. 21, 2010 (FR) 1053033

(51) Int. Cl. H04W 4/00

(52) U.S. Cl. 455/413

(57) ABSTRACT

System for the recording and retrieval of voice messages provided to be arranged in the passenger compartment of an automobile vehicle that includes a control interface, a display screen that displays a list of a plurality of (N) columns for classification of the voice messages according to the subject of their content, each column being selectable by the control interface, a voice message recording device that is controlled by the control interface and makes it possible to record a voice message while associating it with a selected column, a sound emitting device that is controlled by the control interface and makes it possible to emit the voice message or messages recorded in the selected column, and a communications device.

### CROSS-REFERENCE TO RELATED APPLICATION

This application claims the benefit under 35 U.S.C. §371 of published PCT Patent Application Number PCT/EP 2011/053799, filed Mar. 14, 2011, which claims priority to French patent application number FR1053033 filed on 21 Apr. 2010, and was published as WO2011/131418 on Oct. 25, 2011, the entire contents of which is hereby incorporated by reference herein.

### TECHNICAL FIELD OF INVENTION

The present invention relates to a system for the recording and retrieval of voice messages provided to be arranged in the passenger compartment of an automobile vehicle.

### BACKGROUND OF INVENTION

At present, no existing system makes it possible for a driver or the passenger of a vehicle to take notes or make appointments easily without recourse to the use of paper and pen. This type of solution has numerous drawbacks, in particular, when the vehicle is moving, which causes vibrations and disturbs use of the pen.

Certain mobile communications apparatuses of the smart phone type can give access to this type of function in the interior of the vehicle, but they need either the use of a complex combination of keys, which may give rise to significant risks for driving of the vehicle if the driver wishes to use it, or a complex voice recognition system of which the reliability is not always perfect, in particular taking into account the ambient noises in the passenger compartment of the vehicle.

### SUMMARY OF THE INVENTION

The present invention aims to remedy the drawbacks of the existing solutions by proposing a reliable and efficient system that is easier to use. The system according to the invention aims in particular to make it possible for the driver of a vehicle to record and retrieve voice messages in his vehicle without being disturbed in his driving owing to an optimized control interface, but also to make it possible for the driver to be informed of these messages on a mobile communications apparatus once he has left the vehicle.

For this purpose, the present invention proposes an on-board system for the recording and retrieval of voice messages provided to be arranged in the passenger compartment of an automobile vehicle, characterized in that the system comprises: a control interface, a display screen which displays a list of N columns for classification of the voice messages according to the subject of their content, each column being selectable by the control interface, a voice message recording device which is controlled by the control interface and which makes it possible to record a voice message while associating it with a selected column, a sound emitting device which is controlled by the control interface and which makes it possible to diffuse the voice message or messages recorded in the selected column, a communications device which is provided for transferring, in the recording mode, the voice message which is received and the associated column information to the memory of a mobile communications apparatus and for transferring, in the retrieval mode, the voice message or messages recorded in the selected column to the sound emitting device, the mobile communications apparatus being provided to be carried by a user when he leaves the vehicle.

The system according to the invention is particularly advantageous because of its simplicity of use. In fact, the number of necessary steps to be implemented, whether in the retrieval mode or in the recording mode, is reduced to the minimum. Furthermore, it requires very few components, while offering a highly useful functionality for the user.

According to further advantageous characteristics of the invention: in the retrieval mode, the columns are provided to scroll successively, one after the other, in a selection zone of the screen, scrolling of the columns in the selection zone being controlled by the control interface, the control interface comprises at least two scrolling keys which make it possible to scroll the columns in two opposite directions, and a confirm key which makes it possible to confirm the selected column appearing in the selection zone, confirmation of the selected column causing, in the retrieval mode, emitting of the voice message or messages recorded in the selected column; the control interface comprises four direction keys corresponding to four separate directions, two direction keys constituting the two scrolling keys and the other two direction keys constituting first and second auxiliary keys; in the retrieval mode, actuation of the first auxiliary key causes deletion of the voice message or messages in the selected column and actuation of the second auxiliary key causes switching to the recording mode; in the recording mode, the N columns are displayed in the form of N icons of which the relative positioning on the screen corresponds overall to the relative positioning of the direction keys, each direction key corresponding to a separate column, the actuation of a direction key directly causing the start of recording of a voice message in the selected column; the display screen is of the tactile type; the communications device is of the wireless type, for example of the BLUETOOTH® type.

The invention also proposes a mobile communications apparatus, in particular of the portable telephone type, characterized in that it comprises a device for the recording and retrieval of voice messages capable of cooperating with the system according to any of the preceding claims.

Advantageously, the mobile communications apparatus comprises an alarm device that is provided to remind the user of the presence of voice messages in the memory of the mobile communications apparatus when he is situated outside the vehicle.

The invention also proposes a method for the control of an on-board system for the recording and retrieval of voice messages with which an automobile vehicle is equipped, the system comprising a control interface provided with N direction keys and a confirm key, the method comprising the following steps: in the recording mode, displaying on a screen a list of N columns for classification of the voice messages according to the subject of their content, the N columns being displayed in the form of N icons of which the relative positioning corresponds overall to the relative positioning of the direction keys so that one direction key is associated with each column, selecting a column and simultaneously starting recording of a voice message while actuating the associated direction key, transferring the voice message and the associated column information to the memory of a mobile communications apparatus; in the retrieval mode, displaying on the screen the N columns in the form of a scrolling list, selecting a column by actuating a direction key and scrolling the columns one after the other in a selection zone of the screen until the chosen column is displayed, confirming the selected column by actuating the confirm key so as to cause emitting of the message or messages recorded in the selected column.

Preferably, in the retrieval mode, on confirmation of the selected column, the message or messages recorded in the selected column are transmitted to a sound emitting device from the memory of the mobile communications apparatus.

### BRIEF DESCRIPTION OF DRAWINGS

Further characteristics, aims and advantages of the invention will be apparent on reading the detailed description below, and with reference to the attached drawings, given by way of example without limitation, in which:

FIG. 1 is a block diagram which shows schematically the system for the recording and retrieval of voice messages that is realized according to the invention and is arranged in an automobile vehicle;

FIG. 2 is a front view which shows schematically a portion of the vehicle dashboard of FIG. 1 comprising the system of FIG. 1;

FIG. 3 is a view similar to that of FIG. 2 that shows schematically the system of FIG. 1 in the retrieval mode;

FIGS. 4 to 6 are views similar to that of FIG. 3 that show schematically different steps of functioning of the system in the recording mode; and

FIG. 7 is a view similar to that of FIG. 3 that shows schematically a step of deletion of a voice message in the retrieval mode.

### DETAILED DESCRIPTION

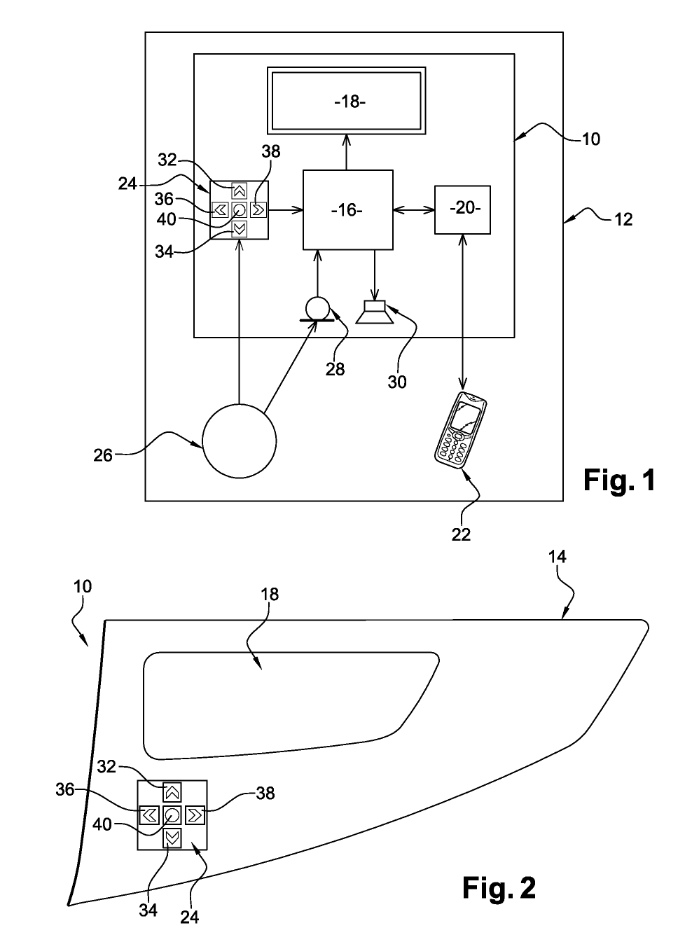

In FIG. 1 is shown schematically an on-board system 10 for the recording and retrieval of voice messages according to the instructions of the invention. This system 10 is arranged in the passenger compartment of an automobile vehicle 12. It can be integrated in the instrument panel 14 of the vehicle 12, for example in the form shown in FIG. 2.

The system 10 according to the invention here comprises a central processing unit 16 that controls a display screen 18, and a communications device 20 allowing the transfer of information between the central processing unit 16 and a mobile communications apparatus 22 such as a portable telephone. The mobile communications apparatus 22 is provided with a memory allowing storage of the information transmitted by the system 10. The system 10 further comprises a control interface 24 that allows a user 26 to control functioning of the system 10.

Preferably, the communications device 20 is of the wireless type, for example of the BLUETOOTH® type. Naturally, another type of communications device 20 could be used, particularly a device of the WIFI® type.

The mobile communications apparatus 22 is provided to be carried by the user, for example the driver 26, when he leaves the vehicle 10.

The central processing unit 16 is connected to a sound recording device 28 of the microphone type with the object of allowing the system 10 to record voice messages VM emitted by the user 26, and it is connected to a sound emitting device 30 of the loudspeaker type with the aim of allowing the system to diffuse previously recorded voice messages VM.

According to the embodiment shown here, the control interface 24 consists of electrical switches which are arranged so as to form four direction keys 32, 34, 36, 38 disposed in a cross and a confirm key 40 disposed at the center of the cross.

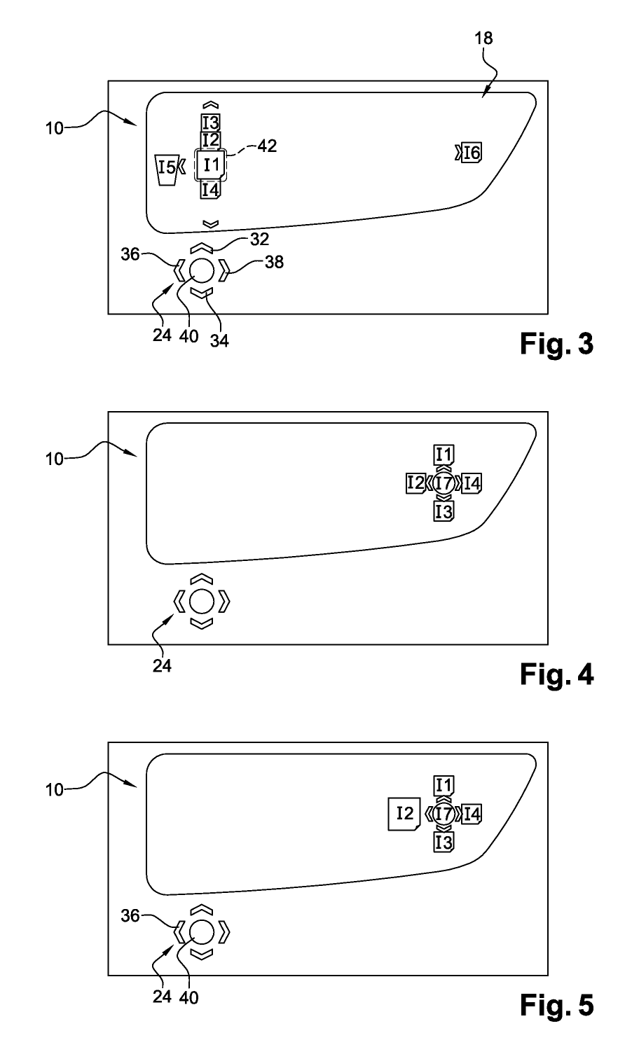

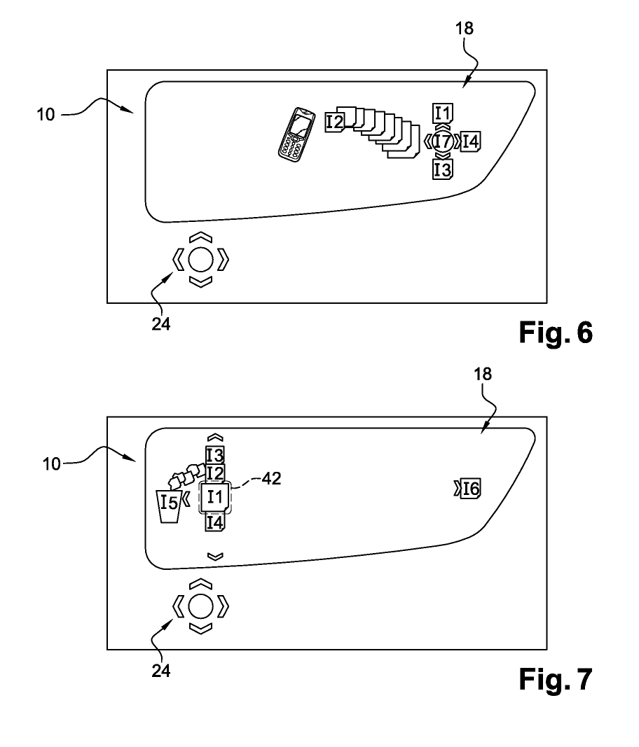

According to the instructions of the invention, as illustrated by FIGS. 3 to 7, the display screen 18 is provided for displaying a list of N columns Cn for classification of the voice messages VM according to the subject of their content and their order of appearance. Furthermore, the system 10 allows the user 26, via the control interface 24, to select a column Cn and to select a mode of functioning between a recording mode and a retrieval mode.

Preferably, the number N of columns Cn is equal to four and the columns are the following: a first column C1 for voice messages VM associated with medical questions, a second column C2 for voice messages VM associated with family or friends questions, a third column C3 for voice messages VM associated with shopping questions or food errands, and a fourth column C4 for voice messages VM associated with miscellaneous questions.

In the recording mode, a voice message VM pronounced by the user 26 is received by the sound recording device 28 and recorded in the memory of the mobile communications apparatus 22, via the communications device 20, being classified according to the column Cn selected for recording. The voice message VM is therefore stored with associated column Cn information.

In the retrieval mode, the voice message or messages VM, which are stored in the memory of the mobile communications apparatus 22 and which are classified in the selected column Cn, are diffused in the passenger compartment of the vehicle 12 by the sound emitting device 30, via the communications device 20.

In the retrieval mode, as shown in FIG. 3, the system 10 displays on the screen 18 the columns Cn in the form of four icons I1, I2, I3, and I4 capable of scrolling successively, one after the other, in a selection zone 42 of the screen 18. According to the example shown, the icons I1, I2, I3, and I4 are provided for scrolling in a vertical direction, from bottom to top looking at FIG. 3, scrolling of the columns Cn in the selection zone 42 being controlled by the up 32 and down 34 direction keys that then constitute scrolling keys.

In the retrieval mode, pressing on the confirm key 40 directly causes reading and emitting of the voice message or messages VM of the selected column Cn, that is, the column Cn which appears in the selection zone 42.

After confirmation and before the start of reading of the voice message or messages VM of the selected column Cn, said voice messages VM can be transferred from the memory of the mobile communications apparatus 22 to a buffer memory (not shown) of the system 10.

An icon I5 showing a dustbin is arranged to the left of the icons I1, I2, I3, I4 of columns Cn for the purpose of making it possible to selectively delete the content of the columns Cn. Thus, in the retrieval mode, pressing on the left direction key 36 directly causes deletion of the content of the selected column Cn, that is, the column Cn displayed in the selection zone 42, as illustrated by FIG. 7, a graphic animation being used to symbolize the action of deletion.

An icon I6 symbolizing the pick-up of a new voice message VM is displayed on the right of the screen 18 in order to allow switching to the recording mode. Thus, in the retrieval mode, pressing on the right direction key 38 directly causes switching to the recording mode.

The system 10 will now be described in more detail when it is functioning in the recording mode, illustrated by FIGS. 4 to 6, where the columns Cn are displayed in the form of four icons I1, I2, I3, I4 of which the relative positioning on the screen 18 corresponds overall to the relative positioning of the direction keys 32, 34, 36, 38. The four icons I1, I2, I3, I4 are therefore here arranged in a cross, and each direction key 32, 34, 36, 38 corresponds to a separate column Cn, the actuation of a direction key 32, 34, 36, 38 directly causing the start of recording of a voice message VM in the selected column Cn.

In the example shown in FIG. 5, the user 26 has exerted pressure on the left direction key 36, which corresponds to the second column C2, which has caused the start of recording of the voice message VM that will be classified in the second column C2.

Stopping of recording of the voice message VM is effected for example by pressing on the confirm key 40. Alternatively or additionally, the system 10 may provide for automatically stopping recording when it detects a prolonged silence of the user 26, or recording may be stopped by pressing on any key of the interface 24, which simplifies the ergonomics of the system 10 by avoiding the user 26 having to concentrate on the positioning of the keys, for example when the user 26 is the driver of the vehicle 12. Automatic stopping of recording may also be affected after a predefined time in the system 10.

Preferably, the voice message VM in the process of being recorded is stored in the buffer memory of the system 10, and the voice message VM is not transferred to the memory of the mobile communications apparatus 22 until the end of recording. FIG. 7 shows a graphic animation that is implemented at the end of recording to symbolize the step of transfer of the voice message VM that has just been recorded to the mobile communications apparatus 22.

Naturally, it is also possible to record the voice messages VM in parallel in the memory of the mobile communications apparatus 22 and in an additional memory provided in the on-board system 10.

In the recording mode, when no voice message VM is in the process of being received, pressing on the confirm key 40 causes switching to the retrieval mode as shown in FIG. 3. An icon I7 symbolizing return to the retrieval mode is arranged at the center of the cross formed by the four column Cn icons I1, I2, I3, and I4.

The present invention has been described here with a control interface 24 consisting of keys arranged outside the display screen 18. Naturally, these keys can be arranged at various locations of the passenger compartment of the vehicle, particularly on the steering wheel, to facilitate use of the control interface 24 by the vehicle driver.

According to a variant, the display screen 18 can be a touch screen, and the control interface 24 can then be formed by the screen 18 itself. In this case, a touchpad may be displayed on the screen 18, or the control keys may directly consist of the icons I1, I2, I3, I4, I5, I6, and I7.

It is noted that the mobile communications apparatus 22 is provided with a device for the recording and retrieval of voice messages VM capable of cooperating with the system 10, that is, it allows the mobile communications apparatus 22 to communicate with the communications device 20 of the system 10 according to the invention, and it allows the user 26 to retrieve the voice messages VM directly from the mobile communications apparatus 22 when he is located outside the vehicle 12. The device for the recording and retrieval of voice messages VM of the mobile communications apparatus 22 for this purpose comprises a program adapted to the system 10 according to the invention.

Preferably, the mobile communications apparatus 22 comprises an alarm device that is provided for reminding the user 26 of the presence of voice messages VM in the memory of the mobile communications apparatus 22 when he is situated outside the vehicle 12.

1. An on-board system for the recording and retrieval of one or more voice messages, said system configured to be arranged in the passenger compartment of an automobile vehicle, and operable to a recording mode and a retrieval mode, the system comprising:
a control interface configured to be installed in the passenger compartment and provide a user a means to control the system,
a display screen configured to display a list of a plurality of columns for classification of the voice messages according to the subject of their content, each column being selectable by the control interface,
a sound recording device operable to record a voice message, wherein the system is configured to associate the voice message with a selected column displayed on the display screen,
a sound emitting device operable to emit the voice messages recorded by the sound recording device and associated with the selected column,
a communications device, configured to transfer the voice message and the associated column information to a memory of a mobile communications apparatus when the system is in the recording mode, and transfer the voice message to the sound emitting device when the system is in the retrieval mode, the mobile communications apparatus configured to be carried by a user when the user is away from the vehicle, wherein when the system is in the retrieval mode, the columns scroll successively, one after the other, in a selection zone of the display screen in response to inputs by the user to the control interface, wherein the control interface comprises at least two scrolling keys configured to enable the user to scroll the columns in two opposite directions, and a confirm key configured to enable the user to confirm the selected column appearing in the selection zone, wherein the confirmation of the selected column causing, in the retrieval mode, emitting of the voice message associated with the selected column.

2. The system according to claim 1, wherein the control interface comprises four direction keys corresponding to four separate directions, two direction keys constituting the two scrolling keys and the other two direction keys constituting first and second auxiliary keys.

3. The system according to claim 2, wherein when the system is in the retrieval mode, actuation of the first auxiliary key causes deletion of the voice message or messages in the selected column, and actuation of the second auxiliary key causes switching to the recording mode.

4. The system according to claim 2, wherein while the system is in the recording mode, the plurality of columns are displayed in the form of a plurality of icons of which the relative positioning on the display screen corresponds overall to the relative positioning of the direction keys, each direction key corresponding to a separate column, the actuation of a direction key directly causing the start of recording of a voice message in the selected column.

5. The system according to claim 1, wherein the display screen (18) is of the tactile type.

6. The system according to claim 1, wherein the communications device is of the wireless type.

7. A mobile communications apparatus comprising:
a device for the recording and retrieval of voice messages and configured to with the system of claim 1.

8. The mobile communications apparatus according to claim 1, wherein the mobile communications apparatus comprises an alarm device to remind the user of the presence of voice messages in a memory of the mobile communications apparatus when the user is situated outside the vehicle.

9. A method for the control of an on-board system installed in an automobile and configured for the recording and retrieval of voice messages, the system comprising a control interface configured with a plurality of direction keys and a confirm key, and operable to a recording mode and a retrieval mode, the method comprising the following steps:
while in the recording mode:
displaying on a screen (18) a plurality of columns for classification of the voice messages according to the subject of their content, the plurality of columns being displayed in the form of a plurality of icons of which the relative positioning of the icons on the display corresponds overall to the relative positioning of the direction keys so that each direction key is associated with a column,
selecting a column and simultaneously starting recording of a voice message in response to actuating the corresponding direction key,
transferring the voice message and the associated column information to a memory of a mobile communications apparatus,
while in the retrieval mode:
displaying on the screen the plurality of columns in the form of a scrolling list,
selecting a column in response to actuating a direction key and scrolling the columns displayed one after the other in a selection zone of the display screen until a desired column is displayed,
confirming the selected column in response to actuating the confirm key emitting of the voice message or messages recorded in the selected column.

10. The method according to claim 9, wherein upon confirmation of the selected column, the voice message or messages associated with the selected column are transmitted to a sound emitting device (30) from the memory of the mobile communications apparatus (22).
